(19) United States
(12) Patent Application Publication
(10) Pub. No.: US 2017/0195668 A1
(43) Pub. Date: Jul. 6, 2017

(54) TELEVISION PCB TESTING DEVICE

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Huabing Huang, Tianjin (CN)

(21) Appl. No.: 15/245,631

(22) Filed: Aug. 24, 2016

Related U.S. Application Data
(63) Continuation of application No. PCT/CN2016/088857, filed on Jul. 6, 2016.

(30) Foreign Application Priority Data
Dec. 31, 2015 (CN) 201521143125.6

(51) Int. Cl. H04N 17/00

(52) U.S. Cl. CPC H04N 17/004

(57) ABSTRACT

Disclosed is a television PCB testing device. The television PCB testing device includes: a television PCB, a signal converter and a display device; wherein the television PCB is electrically connected to the signal converter, and the signal converter is electrically connected to the display device. With the device, PCBs having different resolutions and different interface types may commonly use a common small-size television or monitor as a display device.

### CROSS REFERENCE TO RELATED APPLICATIONS

This application is a continuation of International Application No. PCT/CN2016/088857, filed on Jul. 6, 2016, which is based upon and claims priority to Chinese Patent Application No. 201521143125.6, filed on Dec. 31, 2015, the entire contents of which are incorporated herein by reference.

### TECHNICAL FIELD

The present disclosure relates to the technical field of television PCB testing, and more particularly, to a television PCB testing device.

### BACKGROUND

At present, manufactured television PCBs are subjected to rigid tests, and are then applied to assembly of televisions. However, currently, in factories, during the manufacturing and testing processes, liquid crystal display (LCD) panels of corresponding models, together with display devices, are used for testing the functions of the television PCBs. Such testing method accommodates requirements on testing small-size televisions, which, however, is insufficient to test large-screen televisions, for example, televisions over 50 inches. In particular, the current televisions have different resolutions and interface types, and thus it is not likely to test the televisions by using a specific model of liquid crystal display panel.

### SUMMARY

To overcome the defects in the conventional related products, the present disclosure provides a television PCB testing device. With the device, PCBs having different resolutions and different interface types may commonly use a common small-size television or monitor as a display device.

To solve the above technical problem, embodiments of the present disclosure employ the following technical solution:

An embodiment of the present disclosure provides a television PCB testing device, including a television PCB, a signal converter and a display device; wherein the television PCB is electrically connected to the signal converter, and the signal converter is electrically connected to the display device.

As a further improvement to the embodiment of the present disclosure, the television PCB outputs test signals in a V BY ONE format and an LVDS format.

As a further improvement to the embodiment of the present disclosure, the signal converter includes a first conversion element, a second conversion element and a third conversion element, wherein the second conversion element is electrically connected to the first conversion element and the third conversion element respectively.

As a further improvement to the embodiment of the present disclosure, the display device includes a television or a monitor equipped with a digital video interface or a high-definition multimedia interface.

As a further improvement to the embodiment of the present disclosure, the television PCB is electrically connected to the signal converter via a cable, and the signal converter is electrically connected to the display device via an interface wire.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a principle diagram of a television PCB testing device according to the present disclosure; and

FIG. 2 is a circuit diagram of a signal converter according to the present disclosure.

### DETAILED DESCRIPTION

For better understanding of the present disclosure, the present disclosure is thoroughly described with reference to relevant accompanying drawings. The accompanying drawings show embodiments of the present disclosure. However, the present disclosure may be implemented in a plurality of forms or ways, and is not limited to the embodiments described herein. On the contrary, the embodiments described herein are intended to make the disclosure of the present disclosure more clearly and thoroughly understood.

Unless otherwise defined, all the technical and scientific terms used in this specification convey the same meanings as the meanings commonly understood by a person skilled in the art. Additionally, the terms used in the specification the present disclosure are merely for describing the objective of the specific embodiments, and are not intended to limit the present disclosure.

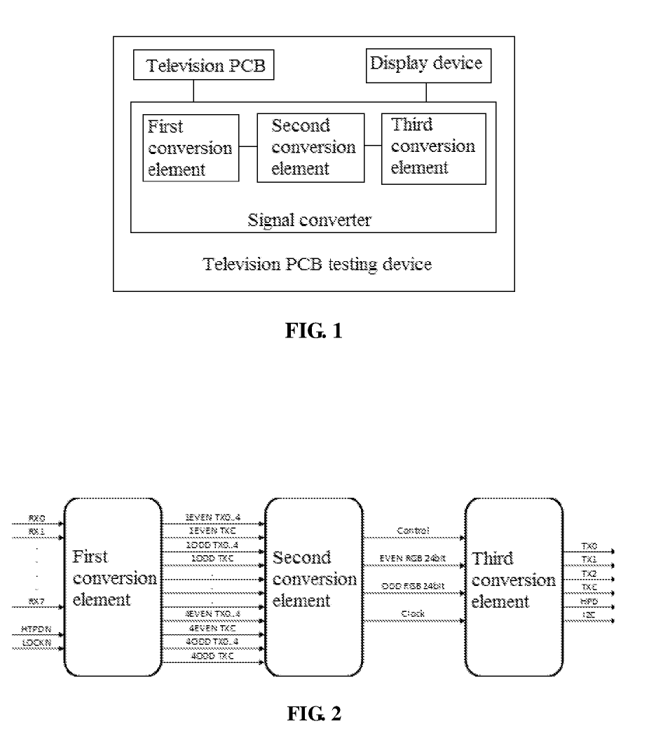

Referring to FIG. 1, a television PCB testing device includes a television PCB, a signal converter and a display device; wherein the television PCB is electrically connected to the signal converter, and the signal converter is electrically connected to the display device.

The television PCB includes television PCBs available on the market which have different resolutions and different interface types. The television PCB transmits test signals, which include V BY ONE (a digital interface standard developed for image transmission) signals and LVDS (low-voltage differential signaling) signals, and the resolutions include, but not limited to, Full High Definition (FHD), Quad Full High Definition (QFHD), and the like types.

The signal converter carries out signal mode conversion, and converts a V BY one or LVDS signal into a Digital Visual Interface (DVI) or High Definition Multimedia

Interface (HDMI) signal, which is input to the display device via an interface wire in the corresponding mode.

The display device includes a small-size television or monitor or the like having the DVI or HDMI interface, and the display device receives the DVI or HMDI signal and tests relevant functions of the television PCB.

Referring to FIG. 2, the signal converter includes a first conversion element, a second conversion element and a third conversion element, wherein the second conversion element is electrically connected to the first conversion element and the third conversion element respectively. The first conversion element is a V BY ONE-to-LVDS element, and the V BY ONE-to-LVDS element converts a V BY ONE signal into a LVDS signal and outputs the signal. The V BY ONE-to-LVDS element has 8-lane V BY ONE signal inputs, wherein each 2-lane V BY one signals are converted into 1-lane dual link LVDS signals, and there are totally 4-lane dual link LVDS signal outputs. The second conversion element is a video processor (image information processor) element, which is a control system of the signal converter, implements signal control and mode conversion and the like functions, and converts the 4-lane dual link LVDS signals input by the first conversion element into RGB signals for output. The third conversion element is an RGB-to-TMDS element, which receives an RGB signal input by the second conversion element, and converts the RGB signal into a DVI or HDMI-compliant TMDS (transition minimized differential signaling) signal.

The operation steps of the television PCB testing device are as follows:

Step S1: A television PCB outputs a signal to a signal converter via a cable.

Step S2: The signal converter converts a V BY ONE or LVDS signal output by the television PCB into a DVI or HDMI signal.

Step S3: A display device receives the DVI or HDMI signal and tests relevant functions of the television PCB.

According to the present disclosure, V BY ONE and LVDS signals output by the PCB are converted into signals that can be received by a common small-size television or monitor via a signal converter, such that the testing of the PCB is not subjected to restrictions of the specification and size of the liquid crystal display panel.

The above embodiment describes at least one implementation manner of the present disclosure. However, the implementation manner of the present disclosure is not limited to the above embodiment. Any variations, modification, substitutions, combinations, or simplifications, or the like equivalent replacements made to the present disclosure without departing from the spiritual essence and principle of the present disclosure shall all be covered within the protection scope of the present disclosure.

What is claimed is:

1. A television PCB testing device, comprising:
a television PCB, a signal converter and a display device; wherein the television PCB is electrically connected to the signal converter, and the signal converter is electrically connected to the display device.

2. The television PCB testing device according to claim 1, wherein the television PCB outputs test signals in a V BY ONE format and an LVDS format.

3. The television PCB testing device according to claim 1, wherein the signal converter includes a first conversion element, a second conversion element and a third conversion element, wherein the second conversion element is electrically connected to the first conversion element and the third conversion element respectively.

4. The television PCB testing device according to claim 1, wherein the display device includes a television or a monitor equipped with a Digital Visual Interface or a High Definition Multimedia Interface.

5. The television PCB testing device according to claim 1, wherein the television PCB is electrically connected to the signal converter via a cable, and the signal converter is electrically connected to the display device via an interface wire.
